(19) United States
(12) Patent Application Publication
(10) Pub. No.: US 2006/0171483 A1
(43) Pub. Date: Aug. 3, 2006

(54) Decoder for a multiplexed transmission system

(75) Inventors: Yugang Jia, Bristol (GB); Christophe Andrieu, Bristol (GB); Magnus Stig Torsten Sandell, Bristol (GB); Robert Jan Piechocki, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/257,012

(22) Filed: Oct. 25, 2005

(30) Foreign Application Priority Data
Dec. 2, 2004 (GB) 0426486.7

(51) Int. Cl. H04L 1/02

(52) U.S. Cl. 375/267

(57) ABSTRACT

Information is decoded from a signal received from a transmission over a MIMO channel from a plurality of transmit antennas, by means of a decoder and a corresponding decoding method. The signal is received on a plurality of receive antennas, and the information is encoded as a string of symbols over space and time and/or frequency. Each transmitted symbol has one of a plurality of values The decoding method comprises the steps of identifying a predetermined number of sets of symbol values, the sets being the most likely combinations of symbol values to be presented at the transmit antennas at a given time instant, and, for each symbol permitted for transmission, determining and outputting the probability of received information corresponding to the transmission of the symbol at a given antenna, on the basis of the other transmit antennas transmitting the symbol values of one of the identified sets. The latter step comprises determining the probability of a given symbol being transmitted at a given transmit antenna, given that the other transmit antennas are transmitting in accordance with one of the selected combinations identified as the most likely combinations. This is performed for all selected combinations, and the resultant probabilities are added together.

The invention relates to decoding a transmission from a multiplexing transmitter, particularly but not exclusively in a spatially multiplexed MIMO system.

The current generation of WLAN (wireless local area network) standards such as Hiperlan/2 and IEEE802.11a provide data rates of up to 54 Mbit/s. It is acknowledged that the former of these standards originated in Europe, and the latter from the United States, but the application of the standard-specified technology is not restricted by location.

There is a continuing desire for increased data rate transmission in WLANs. Increased data rates, for example for multimedia services, may be achieved by simply increasing the data transmission bandwidth, but this is inefficient and expensive.

MIMO systems have the capability to increase throughput without increasing bandwidth. The throughput can potentially scale linearly with the number of transmit/receive antennas: for example, a four transmit-, four receive-antenna system potentially provides four times the capacity of a single transmit-receive antenna system.

However, receivers for MIMO communications systems are complex because a single receive antenna receives signals from all transmit antennas, causing difficulties in decoding the resultant complex signals.

In a typical MIMO data communications system, a data source provides data (comprising information bits or symbols) to a channel encoder of a transmitter. The channel encoder typically comprises a convolutional coder such as a recursive systematic convolutional (RSC) encoder, or a stronger so-called turbo encoder (which includes an interleaver). More bits are output than are input, and typically the rate is one half or one third. The channel encoder is followed by a channel interleaver and, in this example, a space-time encoder. The space-time encoder encodes an incoming symbol or symbols as a plurality of code symbols for simultaneous transmission from each of a plurality of transmit antennas.

Space-time encoding is represented in an operational embodiment by an encoding machine, described by a coding matrix, which operates on the data to provide spatial and temporal transmit diversity. The encoding machine may be followed by a modulator to provide coded symbols for transmission. Space-frequency encoding may additionally (or alternatively) be employed.

Thus, broadly speaking, incoming symbols are distributed into a grid having space and time and/or frequency coordinates. Where space-frequency coding is employed, the separate frequency channels may be modulated onto OFDM (orthogonal frequency division multiplexed) carriers, a cyclic prefix generally being added to each transmitted symbol to mitigate the effects of channel dispersion, which would otherwise destroy the orthogonality of the OFDM sub-carriers and could introduce inter-symbol interference (ISI).

The encoded transmitted signals propagate through a MIMO channel (for example, wireless electromagnetic transmission) to receive antennas of a receiver, which provide a plurality of inputs to a space-time (and/or frequency) decoder. This has the task of removing the effect of the encoder. The decoder takes the plurality of receive signals from the receive antennas, and from them reconstructs an output comprising a plurality of signal streams, one for each transmit antenna, each carrying so-called soft or likelihood data on the probability of a transmitted symbol having a particular value.

This data is provided to a channel de-interleaver which reverses the effect of the channel interleaver of the transmitter, and then to a channel decoder, such as a Viterbi decoder, which decodes the convolutional code. Typically the channel decoder is a SISO (soft-in soft-out) decoder, that is receiving symbol (or bit) likelihood data and providing similar likelihood data as an output rather than, say, data on which a hard decision has been made. The output of the channel decoder is provided to a data sink, for further processing of the data in any desired manner.

In some communications systems, so-called turbo or iterative decoding is employed in which a soft output from the channel decoder is provided to a channel interleaver, corresponding to the channel interleaver, which in turn provides soft (likelihood) data to the space time decoder for iterative space-time (and/or frequency) and channel decoding. It will be appreciated that, in such an arrangement, the channel decoder provides information on all transmitted symbols to the space time decoder, that is for example including error check bits.

It will be appreciated that, in the communications system described above, both the channel coding and the space-time coding provide time diversity; this diversity is subject to the law of diminishing returns in terms of the additional signal to noise ratio gain which can be achieved. Thus, when considering the benefits provided by any particular space-time/frequency decoder, these benefits are best considered in the context of a system which includes channel encoding.

One of the most complex tasks in such a communications system is the decoding of the space-time (or frequency) block code (STBC). This task is performed by the decoder, and involves trying to separate the transmitted symbols, which interfere with one another at the receiver. The optimal STBC decoder is the a posteriori probability (APP) decoder, which performs an exhaustive search of all possible transmitted symbols. Such a decoder considers every transmitted symbol constellation point for all the transmit antennas and calculates all possible received signals, comparing these to the actually received signal and selecting that with the closest Euclidian distance as the most likely solution.

However the number of combinations to consider is immense even for a small number of antennas, a modulation scheme such as 16 QAM (quadrature amplitude modulation), and a channel with a relatively short time dispersion, and the complexity of the approach grows exponentially with the data rate. The optimal approach can thus be considered as computationally difficult to implement, and not suitable for practical systems as small increases in data rate will result in high computational cost sub-optimal approaches are therefore of technical and commercial interest.

Common choices for space-time block decoding are linear estimators such as zero-forcing and minimum mean-squared error (MMSE) estimators, decision feedback approaches (block decision feedback equalizer, vertical BLAST (Bell Labs LAyered Space Time) decoder) and state-space methods with limited searches such as a sphere decoder.

Other background prior art relating to multi-user systems can be found in ‘Near-Optimal Multiuser Detection in Synchronous CDMA Using Probabilistic Data Association’, (J Luo, K R Pattipati, P K Willett and F Hasegawa IEEE Communication Letters, Vol. 5, No 9, September 2001) and ‘Iterative Receivers for Multiuser Space-Time Coding Systems’ (Ben Lu and Xiaodong Wang, IEEE Journal on Selected Areas in Communications, Vol. 18, No 11, November 2000).

Optimal decoding using an APP decoder is very complex but, on the other hand, the other techniques mentioned above perform poorly. In particular, sub-optimal decoders tend to provide inaccurate soft output information, which can degrade performance significantly in a channel coded system.

It would thus be desirable to provide a decoding technique which provides improved performance without the complexity of the APP approach.

Another popular method for MIMO detection is the Sphere Decoder (SD). The principle of operation of a sphere decoder is disclosed in “Improved methods for calculating vectors of short lengths in a lattice, including a complexity analysis,” (U. Fincke and M. Pohst, Mathematics of Computation, vol. 44, no. 3, pp. 463-471, April 1985).

The complexity of the SD is highly affected by the wireless channel and thus the technique is undesirable for a practical application which allocates fixed memory and computing resources for the detection process.

A first aspect of the invention provides a method of detecting information carried in a signal received from a transmission over a MIMO channel from a plurality of transmit antennas, the information being encoded as symbols over space and time and/or frequency, each symbol being a member of a set of permitted symbols, the method comprising the steps of identifying a predetermined number of combinations of symbol values, the combinations being substantially most likely to be presented at the transmit antennas in a given frame, including initially determining, for each permitted symbol value, the likelihood of a first transmit antenna having transmitted that symbol value, in combination with all other transmit antennas transmitting a nominal estimate to take account of undetected symbols and noise, and selecting and storing at least one most likely symbol values, determining for each stored most likely symbol value the likelihood of said most likely symbol value having been transmitted on said first transmit antenna, in combination with, for each permitted symbol value, a second transmit antenna having transmitted that permitted symbol value and further in combination with all other transmit antennas transmitting a nominal estimate to take account of undetected symbols and noise, and selecting and storing at least one most likely combinations of said most likely symbol values transmitted at said first antenna and said permitted symbol values transmitted at said second antenna, then, in relation to any further transmit antennas, iteratively determining for each stored most likely combination of symbol values the likelihood of said most likely combination having been transmitted on transmit antenna previously considered, in combination with, for each permitted symbol value, a further transmit antenna having transmitted that permitted symbol value and further in combination with all other transmit antennas transmitting a nominal estimate to take account of undetected symbols and noise, and selecting and storing at least one most likely combinations of said most likely combinations transmitted at said previously considered antennas and said permitted symbol values transmitted at said further antenna; and determining an approximation of the likelihood that a transmit antenna has transmitted one of said permitted symbols by determining, for each of the identified combinations, the probability that the transmit antenna has transmitted said symbol in combination with the other transmit antennas transmitting symbols in accordance with said identified combination, and determining the sum of said probabilities, and thereby determining the most likely of said symbols to have been transmitted at said transmit antenna.

In one embodiment of the invention, the undetected symbols are treated as random variables and the nominal symbol estimate is the mean of those symbols.

A second aspect of the invention provides a method of processing a signal received from a MIMO transmission, comprising the steps of determining likelihood data in accordance with the previous aspect of the invention, and de-interleaving the likelihood data to produce convolutional code.

This method may further comprise the step of decoding the channel code to generate likelihood data.

The method may further comprise the step of generating an audio output on the basis of the resultant likelihood information and/or the step of generating a visual output on the basis of the resultant likelihood data.

A third aspect of the invention provides a method of communicating information in a MIMO system, comprising a transmitter having a plurality of transmit antennas and a receiver comprising a plurality of receive antennas, comprising encoding information as symbols, each symbol being a member of a set of permitted symbols, and transmitting the symbols at the transmit antennas modulated in accordance with space and time and/or frequency, then decoding the information at the receiver in accordance with the method of detecting information of the first aspect of the invention.

A fourth aspect of the invention provides a decoder for decoding information borne on a signal received from a transmission over a MIMO channel from a plurality of transmit antennas, the signal being received on a plurality of receive antennas, the information being encoded as a string of symbols over space and time and/or frequency, each transmitted symbol having one of a plurality of values, comprising likely combination determining means for identifying a plurality of combinations of permitted symbol values, the combinations being substantially most likely to be presented at the transmit antennas in a given frame, including likelihood determining means for determining, in an initial mode of operation, for each permitted symbol value, the likelihood of a first transmit antenna having transmitted that symbol value, in combination with all other transmit antennas transmitting a nominal estimate to take account of undetected symbols and noise, and in a further iterative mode of operation, the likelihood of the already considered transmit antenna transmitting one of the stored most likely symbol values or the already considered transmit antennas transmitting one of the most likely combinations of symbol values as the case may be, in combination with a further antenna transmitting, for each permitted symbol value, that symbol value, and all yet to be considered transmit antennas transmitting a nominal estimate to take account of undetected symbols and noise, storage means for storing a selected number, smaller than the number of permitted symbol values, of said most likely symbol values with respect to said initial mode of operation or combinations of values as the case may be; and likelihood data determining means for determining an approximation of the likelihood that a transmit antenna has transmitted one of said permitted symbols including probability component determining means for determining, for each of the identified combinations, the probability that the transmit antenna has transmitted said symbol in combination with the other transmit antennas transmitting symbols in accordance with said identified combination, and probability summation means for determining the sum of said probabilities, and thereby determining the most likely of said symbols to have been transmitted at said transmit antenna.

In accordance with the fourth aspect of the invention, one embodiment of the invention provides that the undetected symbols are treated as random variables and the nominal symbol estimate is the mean of those symbols.

A fifth aspect of the invention provides data processing apparatus operable to receive and process a signal received from a MIMO transmission, comprising a decoder in accordance with the fourth aspect of the invention to produce likelihood data relating to received symbols and a de-interleaver for de-interleaving the likelihood data to produce input to said decoder.

In accordance with the fifth aspect of the invention, the apparatus may include a decoder for decoding the channel code to generate likelihood information.

The apparatus in accordance with the fifth aspect of the invention may further comprise audio output means operable to generate an audio output on the basis of the resultant likelihood information and/or visual output means operable to generate a visual output on the basis of the resultant likelihood information.

A sixth aspect of the invention provides a MIMO communications system, comprising a transmitter having a plurality of transmit antennas operable to encode information as symbols, each symbol being a member of a set of permitted symbols, and to transmitting the symbols at the transmit antennas modulated in accordance with space and time and/or frequency, and a receiver comprising a plurality of receive antennas, operable to decoding the information, and the receiver comprising a decoder in accordance with the fourth aspect of the invention.

An seventh aspect of the invention provides a MIMO communications system, comprising a transmitter having a plurality of transmit antennas operable to encode information as symbols, each symbol being a member of a set of permitted symbols, and to transmitting the symbols at the transmit antennas modulated in accordance with space and time and/or frequency, and a receiver comprising a plurality of receive antennas, operable to decoding the information, and the receiver comprising a data processing apparatus in accordance with the fifth aspect of the invention.

It will be appreciated that the invention can be embodied by a computer apparatus configured by a computer program executed thereby, to perform any of the methods of the invention, and/or to become configured as apparatus of any aspect of the invention.

In that case, the computer program can be introduced by any practical means, such as by optical or magnetic storage media, by signal received such as through a download implemented by means of the internet, by smartcard, flash memory or other integrated circuit storage means, or by configuration using application specific hardware such as an ASIC.

A specific embodiment of the invention will now be described, by way of example only and with reference to the accompanying drawings, in which:

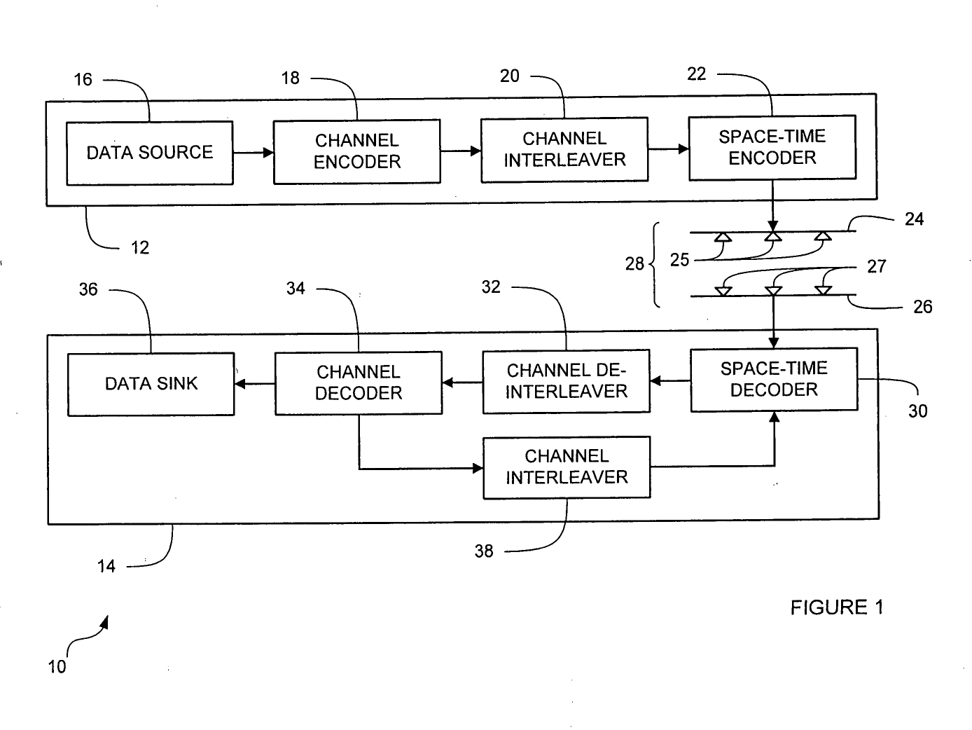

FIG. 1 is a schematic diagram of a MIMO communications system in accordance with a specific embodiment of the invention, including a transmitter and a receiver, the receiver having a space-time decoder;

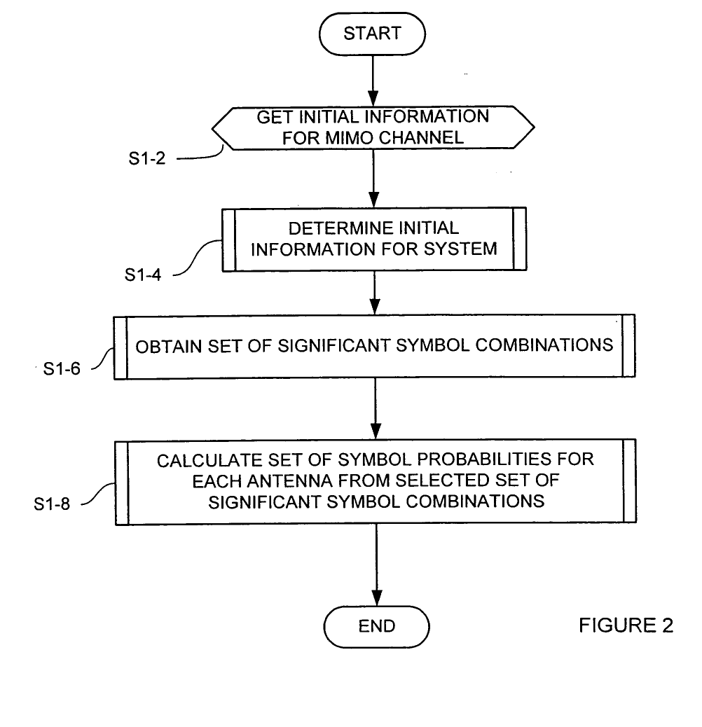

FIG. 2 is a flow diagram illustrating a data extraction process performed by the space-time decoder in receipt of information in accordance with the specific embodiment of the invention;

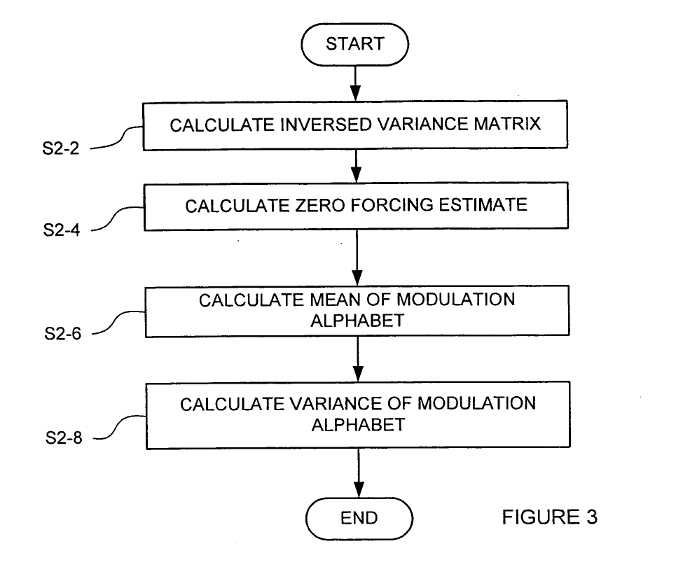

FIG. 3 is a flow diagram illustrating an initialisation process of the process illustrated in FIG. 2;

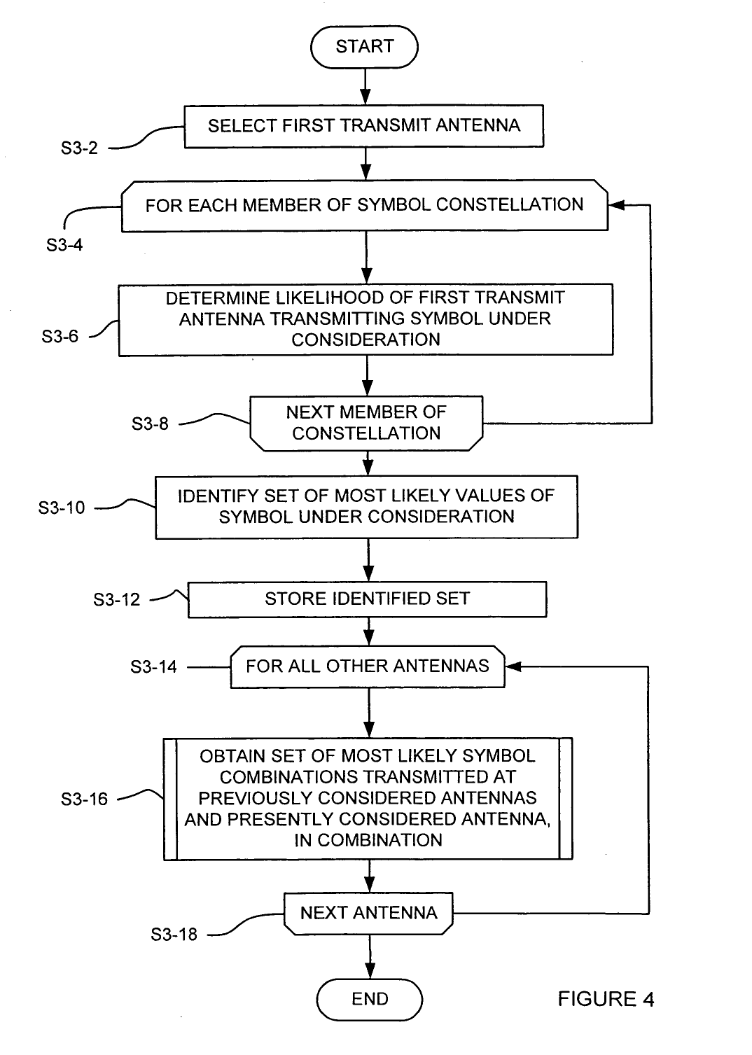

FIG. 4 is a flow diagram illustrating a process of determining a set of significant symbol combinations for use in the decoding process of FIG. 2;

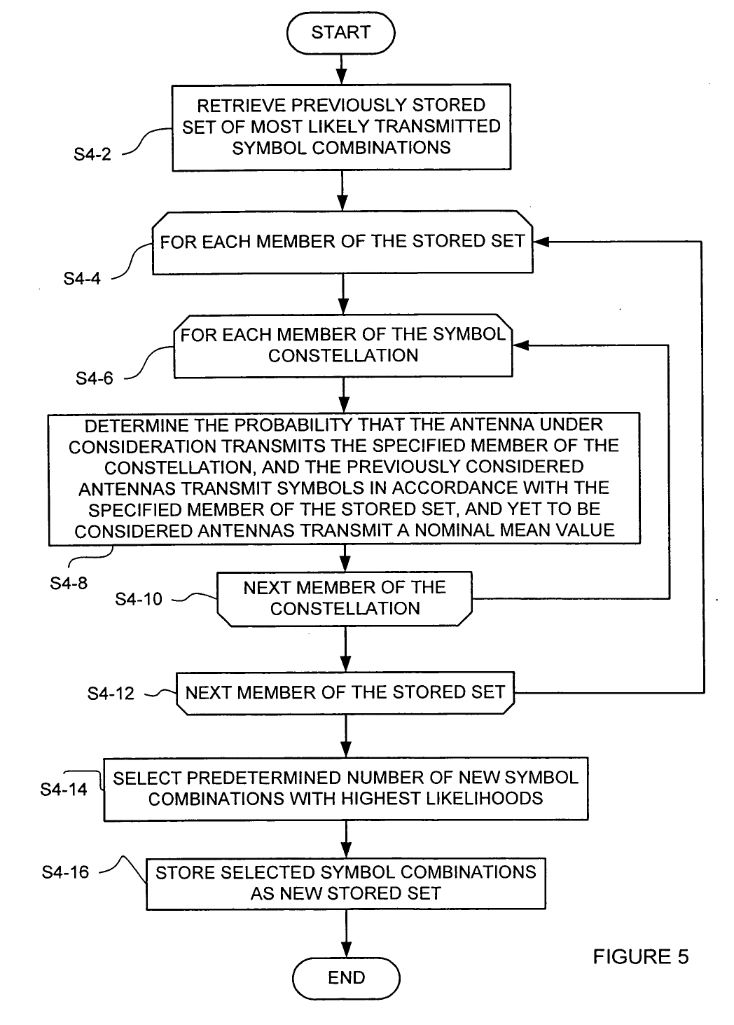

FIG. 5 is a flow diagram of a process called by the process illustrated in FIG. 4, for determining the set of significant symbol combinations;

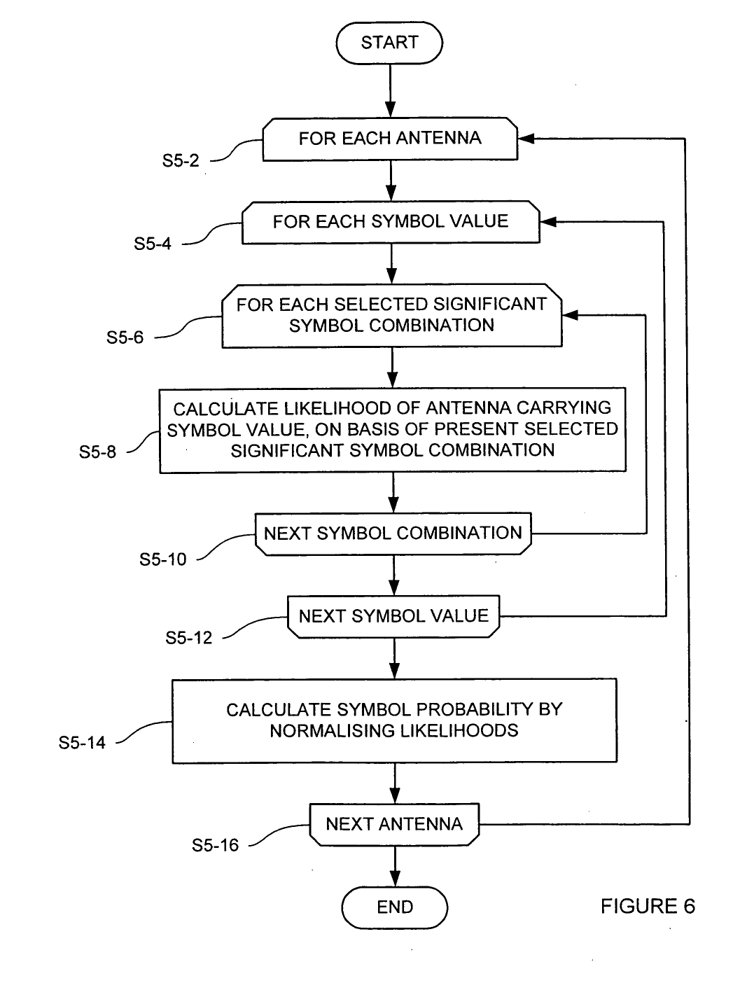

FIG. 6 is a flow diagram of a process of determining symbol probabilities from the symbol combinations derived in the process of FIG. 4, for use in the decoding process of FIG. 2;

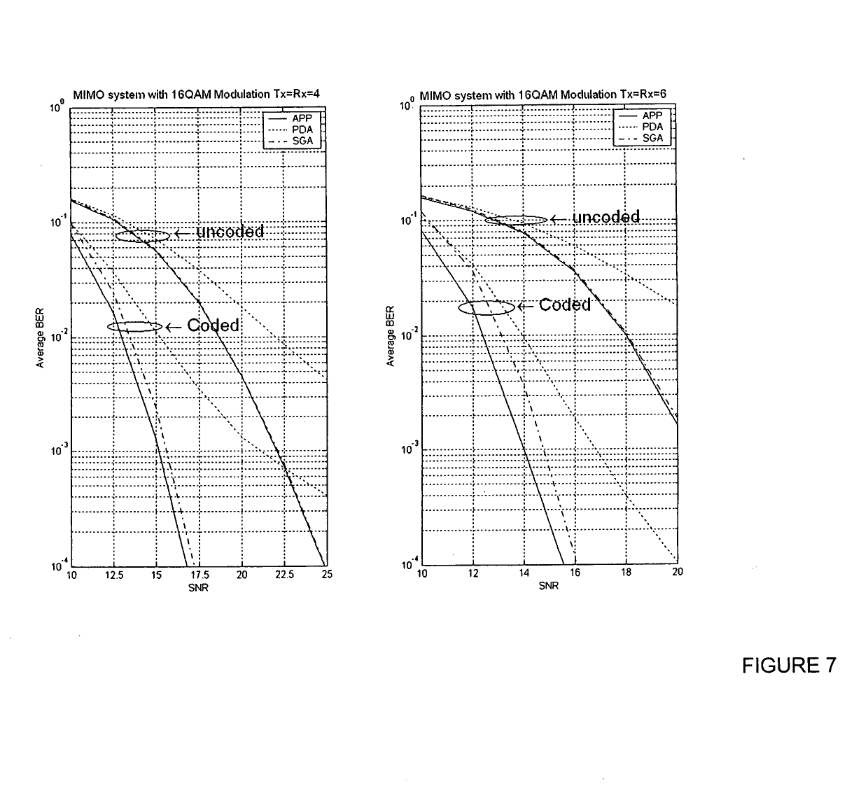

FIG. 7 is a graphical representation of example of performance of the described embodiment in comparison with examples of other decoding processes;

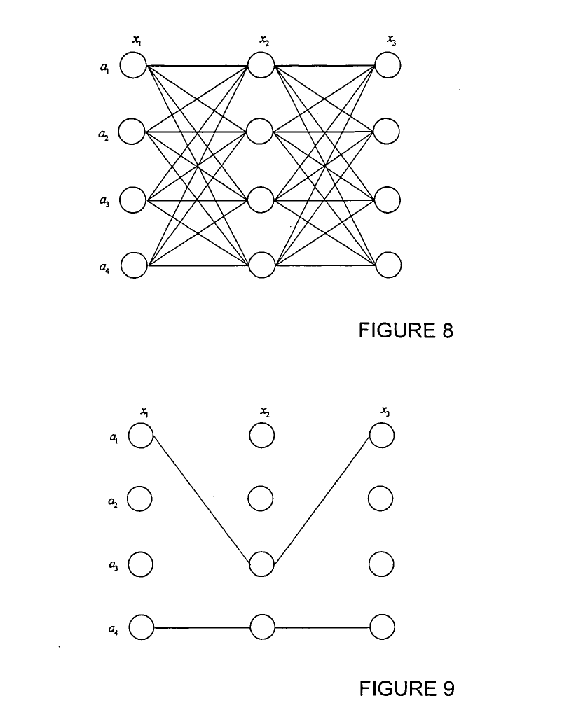

FIG. 8 illustrates diagrammatically the possible combinations of symbols transmitted at transmit antennas, in a given time frame, by means of a trellis, for a specific worked examples of the described embodiment of the invention;

FIG. 9 illustrates diagrammatically the selection of two significant symbol combinations from the trellis illustrated in FIG. 8;

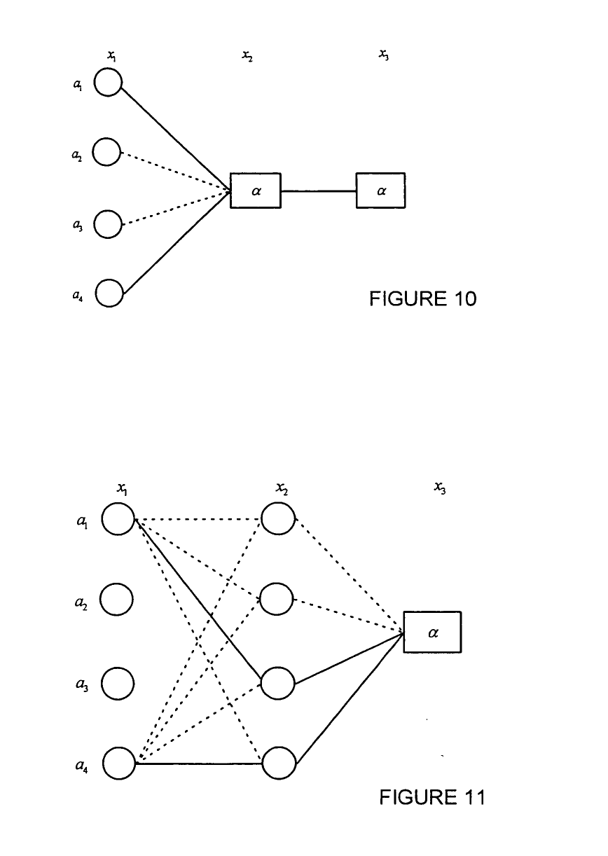

FIG. 10 illustrates diagrammatically the process of approximation for the first antenna, leading to the selection of most likely symbol values for the first antenna;

FIG. 11 illustrates diagrammatically the process of approximation for combinations of values at the first and second antennas, leading to the selection of most likely combinations of symbols for the fist and second antennas considered together;

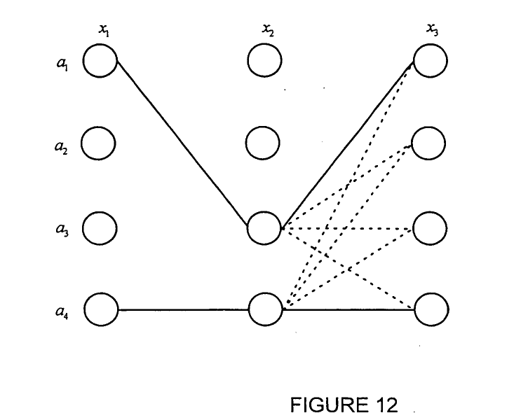

FIG. 12 illustrates diagrammatically the process of determining finally the set of most likely combinations of symbol values, leading to the selection illustrated in FIG. 9.

FIG. 1 illustrates a MIMO data communications system 10 comprising a transmitter device 12 and a receiver device 14. The transmitter device 12 comprises a data source 16, which provides data (comprising information bits or symbols) to a channel encoder 18. The channel encoder 18 in this example comprises a convolutional coder such as a recursive systematic convolutional (RSC) encoder. The channel encoder 18 operates such that more bits are output from the encoder than are presented to its input, and typically the rate is one half or one third.

The channel encoder presents the encoded bits to a channel interleaver 20, in the illustrated embodiment, a space-time encoder 22. The channel interleaver 20 interleaves the bits into symbols in a manner that ensures that errors do not arise due to repeated transmission of a bit in a certain position in a data frame from the same antenna, or that adjacent bits are separated so that errors due to breaks in transmission are possibly capable of being recovered.

The space-time encoder 22 encodes an incoming symbol or symbols as a plurality of code symbols for simultaneous transmission from a transmitter antenna array 24 comprising a plurality of transmit antennas 25. In this illustrated example, three transmit antennas 25 are provided. In the general case, the number of transmit antennas is designated Tₓ.

The encoded transmitted signals propagate through a MIMO channel 28 defined between the transmit antenna array 24 and a corresponding receive antenna array 26 of the receiver device 16. The receive antenna array 26 comprises a plurality Rₓ of receive antennas 27 which provide a plurality of inputs to a space-time (and/or frequency) decoder 30 of the receiver device 16. In this specific embodiment, the receive antenna array 26 comprises three receive antennas 27.

In the general case, it is merely a condition of operability that Rₓ≧Tₓ.

The space-time decoder 30 is operable to remove the effect of the encoder 22. The receiver 14 of the specific embodiment is configured with the transmitter 12 in mind. The output of the space-time decoder 30 comprises a plurality of signal streams, one for each transmit antenna 25, each carrying so-called soft or likelihood data on the probability of a transmitted symbol having a particular value. This data is provided to a channel de-interleaver 32 which reverses the effect of the channel interleaver 20 and outputs convolutional code on the basis of the likelihood data provided by the space-time decoder 30.

The convolutional code output by the channel de-interleaver 32 is then presented to a channel decoder 34. In this example, the channel decoder 34 is a Viterbi decoder, which is operable to decode the convolutional code.

The channel decoder 34 is a SISO (soft-in soft-out) decoder, that is operable to receive symbol (or bit) likelihood data and to provide similar likelihood data as an output rather than, say, data on which a hard decision has been made. The output of channel decoder 34 is provided to a data sink 36, for further processing of the data in any desired manner.

The channel decoder 34 further presents its output to a further channel interleaver 38, of equivalent design to the channel interleaver 20 of the transmitter 12, and thus interleaves the decoded received data in the same manner as the original data had been interleaved in the transmitter 12. This interleaved received data is then presented back to the space-time decoder 30, as a priori data for use in the space-time decoding process.

Operation of the space-time decoder 30 will now be described with reference to FIG. 2 of the drawings. The operation of the space-time decoder 30 enables the decoding of signals modulated using relatively high order modulation schemes, using an average level of complexity associated with a sphere decoder as described and reference above.

For reasons of clarity, the method is described with reference to the general case, with Tₓ transmit antennas 25 and Rₓ receive antennas 27. From this description of the general example, operation of the specific illustrated example with three transmit antennas 25 and three receive antennas 27 will be understood.

By way of background information, the manner in which MIMO communication operates will now be described, along with the manner in which symbols are transferred through the MIMO channel 28.

At each time instant, Tₓ symbols x={x₁, x₂ . . . , x_{T}_{ₓ}} are transmitted from transmit antennas 25 of the transmit antenna array 24. Each transmitted symbol has a value selected from a modulation alphabet A={a₁, a₂ . . . a_{N}}.

At the corresponding time instant at the receive antennas 27 of the receive antenna array 26, Rₓ receive symbols are received. These are, for the following analysis and explanation of the processing method, designated y={y₁, y₂, . . . , y_{R}_{ₓ}}.

The relationship between x and y is:

$$[ \begin{matrix}{y}_{1} \\ {y}_{2} \\ ⋮ \\ {y}_{{R}_{x}}\end{matrix} ] = [ \begin{matrix}h ( 1 , 1 ) & h ( 1 , 2 ) & … & h ( 1 , {T}_{x} ) \\ h ( 2 , 1 ) & h ( 2 , 2 ) & … & h ( 2 , {T}_{x} ) \\ … & ⋮ & ⋰ & ⋮ \\ h ( {R}_{x} , 1 ) & h ( {R}_{x} , 2 ) & … & h ( {R}_{x} , {T}_{x} )\end{matrix} ] [ \begin{matrix}{x}_{1} \\ {x}_{2} \\ ⋮ \\ {x}_{{T}_{x}}\end{matrix} ] + [ \begin{matrix}{n}_{1} \\ {n}_{2} \\ ⋮ \\ {n}_{{R}_{x}}\end{matrix} ] \qquad ( 1 )$$

In equation 1, a nominal element h(i, j) of the matrix is the channel gain between transmitter antenna i and receiver antenna j for i=1,2, . . . Tₓ and j=1,2, . . . Rₓ. The vector n₁, . . . n_{R}_{ₓ} is representational of independent zero Gaussian noise with σ² variance.

Equation 1 can alternatively be expressed in a vector form:
y=Hx+n (2)
where H is the channel matrix with h(i, j) as its (i, j) th entry.

Thus, in an initial step S1-2, the space-time decoder determines, for the MIMO channel, the channel matrix H and the noise variance σ², on the basis of a predetermined pilot sequence preceding the main part of the transmission in question. As the data transmitted in the pilot sequence is known, H and n can be determined and, from n, the noise variance σ² can be estimated. On the basis of these calculations, the received symbols y are mapped to transmitted symbols x.

Then, in step S1-4, initial information for the system is determined, including a zero-forcing estimate of the received data, statistical measures of the symbol alphabet used in modulation, and the inversed variance matrix of the MIMO channel. The manner in which step S1-4 is carried out in accordance with this embodiment is illustrated in further detail in FIG. 3.

As shown in FIG. 3, the method commences in step S2-2 by calculating the inverted variance matrix Λ, on the basis of the determinations of the noise variance σ² and channel matrix H:

$$Λ = \frac{1}{{σ}^{2}} {H}^{H} H \qquad ( 3 )$$

Then, in step S2-4, the zero-forcing estimate \overline{y} is calculated:
\overline{y}=(H^{H}H)⁻¹Hy (4)

The zero forcing estimate is a theoretical quantity resultant from applying the inverse (or the pseudo-inverse, if the inverse cannot be calculated or is not available) of the channel matrix, thereby removing the effect of the channel. The zero-forcing estimate enhances the noise component and does not take into account the symbol alphabet of the system concerned.

Then, two constants are calculated according to the chosen modulation alphabet A={a₁, a₂ . . . a_{N}} of symbols. In step S2-6, the mean α of the modulation alphabet is determined:

$$α = \frac{1}{N} {\sum }_{i = 1}^{N} {a}_{i} \qquad ( 5 )$$

and in step S2-8 the variance γ of the modulation alphabet is determined:

$$γ = \frac{1}{N} {\sum }_{i = 1}^{N} {( {a}_{i} - α )}^{2} \qquad ( 6 )$$

Following completion of the method illustrated in FIG. 3, the method illustrated in FIG. 2 continues. In step S1-6, the set of M significant symbol combinations is obtained. The process determines the most likely combinations of symbol values x={x₁, x₂ . . . , x_{T}_{ₓ}} to arise at the transmit antennas 25. These will then be used in step S1-8 to determine the symbol probabilities to be output in soft information to the channel interleaver 32 and then to the channel decoder 34.

M is a parameter that can be set to any desirable level—low values of M will result in primary detection of a low number of symbol combinations and the benefit gained from such a small set may be limited. On the other hand, a high value of M will result in a large number of symbol combinations being assembled for later use by the channel decoder 34, but the computation requirements will also increase.

The process carried out in step S1-6 is illustrated in further detail in FIG. 4. First, in step S3-2, the first transmit symbol x₁ is considered. In step S3-4, a loop is commenced, for all possible values of the transmit symbol x₁. The transmit symbol can take any of the values defined in the modulation alphabet A={a₁, a₂ . . . a_{N}}. In step S3-6, for each value in the modulation alphabet A, the likelihood Ψ₁ of the symbol x₁ being that value is calculated. This calculation loops in step S3-8 until all values in the modulation alphabet A have been considered.

The likelihood Ψ₁ is determined by considering the contribution of transmission by all other antennas, and channel noise, as Gaussian interference. In general, for antenna i, symbol combination m and constellation point j, the likelihood of the hypothesis that the symbol in question is a given member of the available constellation is computed as:

$$\begin{matrix}{Ψ}_{1} ( i , m , j ) = exp ( - {{w}^{H} ( {Λ}^{- 1} + {Γ}_{i} )}^{- 1} w ) P ( {x}_{i} = {a}_{j} ) \\ {\prod }_{k = 1}^{i - 1} P ( {x}_{k} = {x}_{k}^{( m )} )\end{matrix} \qquad ( 7 )$$

In equation 7, w=\overline{y}−]x₁^{(m)}, . . . , xᵢ₋₁^{(m)}, aⱼ, α, . . . , α]^{T}. That is, w is the difference between the zero-forcing estimate \overline{y} and the m:th candidate symbol combination combined with the j:th constellation point hypothesis and further combined with all remaining undetected symbols being set to the mean α of the modulation alphabet.

Further, Λ⁻¹+Γᵢ is the covariance matrix of the modelled interference. In this covariance matrix, Γᵢ is a diagonal matrix representing the undetected (yet to be detected) symbols, and has its first i diagonal elements set to zero and the remaining ones set to γ (as noted above, the variance of the Gaussian interference by which the undetected symbols are, in this embodiment, represented), and Λ⁻¹ corresponds to the channel noise. Further, P(xᵢ=aⱼ) is the a priori probability that symbol i is, in accordance with the present hypothesis, the j:th constellation point.

Thus, both w and Γᵢ involve the properties of the Gaussian interference estimate by which the effect of the yet to be detected symbols on the yet to be considered transmit antennas are modelled.

Furthermore, the method of this embodiment provides a more efficient way of calculating the inverted matrices.

πᵢ=(Λ⁻¹+Γᵢ)⁻¹ is defined, with its i:th columns as πᵢ and its i:th diagonal element as π_{i,i}. Then, for i=1,2, . . . , Tₓ:

$$\begin{matrix}{\prod }_{i} = {\prod }_{i + 1} - γ \frac{{π}_{i + 1} {π}_{i + 1}^{H}}{1 + {γπ}_{i + 1 , i + 1}} \\ {\prod }_{{R}_{x} - 1} = Λ - γ \frac{{ϖϖ}^{H}}{1 + γς}\end{matrix}$$

where \overline{ω} is the Rₓ:th column of Λ and ζ is the Rₓ:th diagonal element of Λ.

For the first antenna, equation 7 is:
Ψ₁(1,1, j)=exp(w^{H}(Λ⁻¹+Γ₁)⁻¹w)p(x₁=aⱼ) (8)
where w=\overline{y}−[aⱼ, \overline{x}, . . . , \overline{x}]^{T}: i.e. the first antenna is being considered so all antennas yet to be considered are assumed to be transmitting the mean of the modulation alphabet.

It will be appreciated that any suitable method for generating the inversion result will produce acceptable results in the context of the overall method.

The end result of this step is a set of likelihood data for the transmit symbol x₁ on the first antenna. Thus, the steps S3-4 to S3-8 produce N likelihoods Ψ₁(1,1, j) (j=1,2, . . . N) for the first antenna, i.e. the likelihoods that the first antenna, in a given time instant, transmits respective members of the symbol constellation.

In step S3-10, the M most significant of these likelihoods are selected and the corresponding transmit symbol values are then stored in step S3-12 for later processing. For the purpose of this description, these M selected transmit symbol values having the highest likelihoods for transmit symbols x₁ at the first transmit antenna 25 are expressed as {x₁⁽¹⁾, x₁⁽²⁾, . . . , x₁^{(M)}}.

Then, in step S3-14, the process continues for all other antennas in turn. This results in a matrix of likelihood data for each antenna:

$${Ψ}_{1} = ( \begin{matrix}{Ψ}_{1} ( 1 , 1 , 1 ) & {Ψ}_{1} ( 1 , 1 , 2 ) & … & {Ψ}_{1} ( 1 , 1 , N ) \\ {Ψ}_{1} ( 1 , 2 , 1 ) & {Ψ}_{1} ( 1 , 2 , 2 ) & & {Ψ}_{1} ( 1 , 2 , N ) \\ ⋮ & & ⋰ & ⋮ \\ {Ψ}_{1} ( 1 , M , 1 ) & {Ψ}_{1} ( 1 , M , 2 ) & … & {Ψ}_{1} ( 1 , M , N )\end{matrix} ) \qquad ( 9 )$$

In step S3-16, the process obtains a set of M significant symbol combinations for the antenna concerned, by choosing the M symbol combinations with the highest likelihoods out of the MN members of the matrix Ψ₁. These new selected symbol combinations will be of the form {(x₁⁽¹⁾, . . . , xᵢ⁽¹⁾), (x₁⁽²⁾, . . . , xᵢ⁽²⁾), . . . , (x₁^{(M)}, . . . , xᵢ^{(M)})} where i is the present antenna under consideration.

The symbol combinations considered in step S3-16 inevitably all contain the symbol combinations selected when considering the previous antenna. This is because only those symbol combinations selected when considering the previous antenna are used in assembling the matrix Ψ₁. In the case of the second antenna, this means that the M most likely symbol values {x₁⁽¹⁾, x₁⁽²⁾, . . . , x₁^{(M)}} for the first antenna stored in step S3-12 described above are used as a starting point. This is because it follows that the most likely symbol combinations for the first and second antennas will involve the first antenna transmitting one of these symbol values.

The purpose of step S3-16 is to determine a set of M combinations of symbol values for a group of the antennas, and to store these M combinations.

In step S3-18, the process loops back to step S3-14 until all antennas 25 have been considered. Then, the process illustrated in FIG. 4 ends. In the general case, therefore, the set of symbol combinations after consideration of the final transmit antenna 25 will be of the form {(x₁⁽¹⁾, . . . , x_{T}_{ₓ}⁽¹⁾), (x₁⁽²⁾, . . . , x_{T}_{ₓ}⁽²⁾), . . . , (x₁^{(M)}, . . . , x_{T}_{ₓ}^{(M)})}. In the illustrated example, where three transmit antennas 25 are provided, the set of most likely symbol combinations will be {(x₁⁽¹⁾, x₂⁽¹⁾, x₃⁽¹⁾), (x₁⁽²⁾, x₂⁽²⁾, x₃⁽²⁾), . . . , (x₁^{(M)}, x₂^{(M)}, x₃^{(M)})}

The process carried out in step S3-16 will now be described in further detail, with regard to FIG. 5. The process commences in step S4-2 with a retrieval step to retrieve the data determined either in an earlier performance of step S3-16 or in the performance of steps S3-4 to S3-12 described above. In each case, the retrieved data will be in the form {(x₁⁽¹⁾, . . . , xᵢ₋₁⁽¹⁾), (x₁⁽²⁾, . . . , xᵢ₋₁⁽²⁾), . . . , (x₁^{(M)}, . . . , xᵢ₋₁^{(M)})}. It will be understood that, in the case of the first execution of step S3-16, the set of stored sets of symbols will simply be {x₁⁽¹⁾, x₁⁽²⁾, . . . , x₁^{(M)}}.

Then, in step S4-4, a loop is set up for steps to be performed for each symbol combination in the retrieved data {(x₁⁽¹⁾, . . . , xᵢ₋₁⁽¹⁾),(x₁⁽²⁾, . . . , (xᵢ₋₁⁽²⁾), . . . , (x₁^{(M)}, . . . , xᵢ₋₁^{(M)})}, in turn. In step S4-6, a nested loop is established for steps to be carried out for each symbol value aⱼ in the symbol alphabet A. Within these nested loops, a step S4-8 is performed, in which the probability of the antenna xᵢ in question (on this performance of the process of FIG. 5) carrying the symbol value selected for consideration in step S4-6, in combination with the previously considered transmit antennas {x₁, . . . , xᵢ₋₁} transmitting symbols in accordance with the combination of symbol values, (selected from the available set in step S4-4), and the remaining antennas (yet to be considered) transmitting a nominal symbol value which, in this example is set as the mean of the members of the constellation of symbol values. This is achieved by use of the formula of equation 7 above. This effectively is enabled by the assumption that the yet-to-be considered transmit antennas can be assumed to be transmitting Gaussian noise, in order to allow for cross-channel interference.

In step S4-10 and step S4-12, the nested loops are completed. Thus, step S4-8 is performed for each symbol value combination found and stored for previously considered antennas and, for each such combination, for each symbol value in the alphabet. On completion of these loops, therefore, there will be a resultant MN symbol combinations (from M symbol combinations at the previously considered antennas, together with the N available symbol values in the constellation) in the form as shown in equation 9. In step S4-14, the M symbol combinations with the highest likelihoods are selected for further consideration. These symbol combinations, which can be expressed as {(x₁⁽¹⁾, . . . , xᵢ⁽¹⁾), (x₁⁽²⁾, . . . , xᵢ⁽²⁾), . . . , (x₁^{(M)}, . . . , xᵢ^{(M)})}, are then stored in step S4-16.

The process illustrated in FIG. 5 then ends. This process is, by virtue of the loop existing between steps S3-14 and S3-18, performed for each transmit antenna, taking account of the combinations stored in the previous iteration of the process called in step S3-16 in relation to the previously considered antenna. Thus, at the end of the process illustrated in FIG. 4, M symbol combinations have been determined and stored for the Tₓ transmit antennas 25, namely {(x₁⁽¹⁾, . . . , x_{T}_{ₓ}⁽¹⁾), (x₁⁽²⁾, . . . , x_{T}_{ₓ}⁽²⁾), . . . , (x₁^{(M)}, . . . , x_{T}_{ₓ}^{(M)})}.

FIGS. 8 to 12 provide a specific example of use of the above described method for determining a subset of the possible combinations of members of the symbols in the alphabet present at the transmit antennas.

In the illustrated example, the MIMO system has Tₓ=3 transmit antennas and a modulation alphabet with four elements: A={a₁ a₂ a₃ a₄}. All possible symbol combinations of these 3 antennas (symbols) can be represented as a trellis in FIG. 8. Each path in the illustrated trellis represents a possible symbol combination. Thus, this specific example shows that there are a total of 4³=64 available paths through the trellis—i.e. 64 possible combinations of symbols transmitted at the transmit antennas.

Performing an exhaustive search through all possible paths, may find that two of these combinations have by far the highest probability, i.e. the highest joint posterior probabilities, and the symbol combinations corresponding to them are (a₁ a₃ a₁) and (a₄ a₄ a₄) as in FIG. 9.

However, as noted above, the complexity required to identify the M most significant symbol combinations is very high. As described above, the process identifies the symbol combinations via a sequential procedure as follows.

Firstly, the undetected symbols on antennas 2 and 3 are, together with the channel noise, modelled as Gaussian noise. In the method of this embodiment of the invention, these symbols are replaced by the mean α of the modulation alphabet, as the expected value. Similarly, the noise covariance is modified to be (Λ⁻¹+Γ₁). Then, the four approximate likelihoods (using equation 7), which correspond to the four different values possible for x₁, are calculated.

Subsequently, the two paths (a₁ and a₄) with the largest likelihood values (according to equation 7) are selected, and the other paths are omitted from the next iteration. Hence, in this example M=2. FIG. 10 illustrates this procedure to indicate an estimation for the first antenna. The effects of the undetected symbols on the second and third antennas are isolated by replacing their likelihoods by an expected value α, which is the mean of Gaussian interference to be used to model the undetected symbols.

In FIG. 10 the dotted paths correspond to statistically insignificant paths, which are not carried forward to the next iteration. The paths which are, in contrast, selected as being suitable for further consideration, are illustrated by solid lines. Each selected path is then expanded, following the one-step-ahead possibilities. This means that it is necessary to calculate 2×4=8 paths in this iteration. As for the first selection iteration, the two paths ((a₁ a₃) and (a₄ a₄ )), which are found to be the most significant according to equation 7, are selected for further consideration. FIG. 11 illustrates this procedure for determining an approximation for the first and the second antenna. In this case, the identity of the symbol at the third antenna is replaced by its expected value α.

The above calculation and selection can also be performed for antenna 3. The two chosen paths for antenna 3 are expanded to 2×4=8 and their corresponding likelihoods according to equation 7 are calculated. Then, the two paths that are the most significant (i.e. highest probability of being present) are selected.

This suboptimal procedure allows the identification of two highly likely symbol combinations, as illustrated in FIG. 12. These symbol combinations can then be used as the basis for further determination steps which will now be described in their generality in accordance with the specific embodiment, as shown in step S1-8 and described now in further detail with regard to FIG. 6 of the drawings. The symbol probabilities will be output by the space-time decoder to the channel de-interleaver and thence to the channel decoder, constituting the “Soft Information” required for determining the most likely identities of symbols received on the MIMO channel.

The process of FIG. 6 takes the form of a second iteration, calculating symbol probabilities for each antenna, on the basis of the likely symbol combinations derived in the process performed in step S1-6. The process comprises an operational step S5-8 performed within a series of loops. Firstly, the step S5-8 is performed for each antenna, as established in step S5-2. For each antenna, the step S5-8 is performed for each symbol value in the symbol value alphabet A, as established in step S5-4. For each symbol value, the step S5-8 is performed for each of the selected M symbol combinations established and stored in step S1-6.

The operational step S5-8 comprises calculating, for the antenna under consideration, the likelihood of the antenna carrying the symbol under consideration on the basis of the other antennas carrying values according to the symbol combination under consideration. This calculation takes the form:

$${Ψ}_{2} ( i , j , m ) = exp ( {w}^{H} Λ w ) p ( {x}_{i} = {a}_{j} ) {\prod }_{k = 1 , k \neq i}^{M} p ( {x}_{k} = {x}_{k}^{( m )} ) \qquad ( 10 )$$

where w=\overline{y}−[x₁^{(m)}, . . . , xᵢ₋₁^{(m)}, aⱼ, xᵢ₊₁^{(m)}, . . . , x_{T}_{ₓ}^{(m)}]^{T}. Thus, w is again the difference between the zero-forcing estimate \overline{y} and the m:th candidate symbol combination with the j:th constellation point hypothesis. However, this time, as M most likely symbol combinations have been identified in full after the first stage, all symbols other than at the i:th antenna can be assumed to be in accordance with one of those identified most likely combinations.

This operational step S5-8 is thus performed for each of the M selected symbol combinations, and each of the N possible symbol values at the antenna in question. The loops to define this are completed in steps S5-10 and S5-12. This leads to the calculation of MN likelihoods for each antenna.

Then, on completion of the calculation of these MN likelihoods for the antenna in question, in step S5-14, the symbol probability p(xᵢ=aⱼ|y) is determined—the probability that the transmit symbol xᵢ at antenna i is aⱼ given knowledge of the observation vector y. This symbol probability is determined by normalising the MN likelihoods calculated in steps S5-4 to S5-12 for the antenna in question.

$$p ( {x}_{i} = {a}_{j} \vert y ) = \frac{{\sum }_{m = 1}^{M} {Ψ}_{2} ( i , j , m )}{{\sum }_{j = 1}^{N} {\sum }_{m = 1}^{M} {Ψ}_{2} ( i , j , m )} \qquad ( 11 )$$

By virtue of step S5-16, the steps S5-4 to S5-14 to determine this symbol probability, are carried out for each transmit antenna 25.

Working the above described embodiment of the second step through the set of combinations found in the worked example of FIGS. 8 to 12, the probability that antenna 2 transmitted a₂ is calculated as follows:

The true probability of an event that antenna 2 transmitted a₂ is the sum of the probability of antenna 1 and 3 transmitted any of the symbols from A (the set of most likely symbol combinations):

$$P ( {x}_{2} = {a}_{2} \vert y ) = {\sum }_{n 1 = 1}^{N} {\sum }_{n 2 = 1}^{N} P ( {x}_{1} = {a}_{n 1} , {x}_{2} = {a}_{2} , {x}_{3} = {a}_{n 2} \vert y ) \qquad ( 13 )$$

But, as described above, the most likely symbol combinations from antenna 1 and antenna 3 are [x₁=a₁, x₃=a₁] and [x₁=a₄, x₃=a₄]. Therefore, an approximation be made as follows:
P(x₂=a₂|y)≈P(x₁=a₁, x₂=a₂, x₃=a₁|y)+P(x₁=a₄, x₂=a₂, x₃=a₄|y) (14)

The above approximation reduces the number of items in sum from 8 to 2 using the most significant symbol combinations identified.

FIG. 7 illustrates a comparison of performance of the method of this embodiment, against Probability Data Association (PDA) and an optimal algorithm (APP) for spatial multiplex MIMO systems with flat fading channels using 16 QAM. The left-hand figure is for Tₓ=Rₓ=4 antennas and the right one is Tₓ=Rₓ=6 antennas. The bit error rate (BER) is averaged from 10⁴ blocks simulation and the size of each block is 1152 bits.

It will be observed that the present embodiment demonstrates performance substantially higher than for the PDA technique, and consistently close to optimal performance.

It will be appreciated that, in many circumstances, a wireless communications device will be provided with the facilities of a transmitter and a receiver in combination but, for this example, the devices have been illustrated as one way communications devices for reasons of simplicity.

The specific modulation scheme used in the illustrated example is not described, as the number of possible symbols, and the relationship between the symbols (which determines the manner in which symbols are distinguished), are not relevant to the performance of this invention. However, it will be appreciated that the described embodiment can employ BPSK or QPSK, but also the present invention can be applied to higher order modulation schemes with little degradation of performance or computational complexity.

Whereas the present invention has been described with reference to a convolutional channel encoder, it will be appreciated that the invention can be implemented with regard to a stronger encoder such as a so-called turbo encoder (which includes an interleaver).

While the present invention has been described in terms of hardware providing transmitter and receiver functions respectively, it will be appreciated that some, or all, of the apparatus to perform and/or provide the invention may be implemented by means of software directing the operation of a general purpose computer, perhaps suitably configured by hardware to establish wireless communication.

Software to provide implementation of the invention may be provided as a software product, to be loaded onto suitable apparatus to provide the invention. The software product may comprise a data carrier, which may include a magnetic storage device, e.g. a disk or tape, an optical storage device, e.g. an optical disk, for example a Compact Disk or DVD format, or a signal carrying data, e.g. from a storage location remotely accessed and in communication with a device to which the signal is directed, such as via the internet.

1. A method of detecting information carried in a signal received from a transmission over a MIMO channel from a plurality of transmit antennas, the information being encoded as symbols over space and time and/or frequency, each symbol being a member of a set of permitted symbols, the method comprising the steps of:
identifying a predetermined number of combinations of symbol values, the combinations being substantially most likely to be presented at the transmit antennas in a given frame, including
initially determining, for each permitted symbol value, the likelihood of a first transmit antenna having transmitted that symbol value, in combination with all other transmit antennas transmitting a nominal estimate to take account of undetected symbols and noise, and selecting and storing one or more most likely symbol values,
determining for each stored most likely symbol value the likelihood of said most likely symbol value having been transmitted on said first transmit antenna, in combination with, for each permitted symbol value, a second transmit antenna having transmitted that permitted symbol value and further in combination with all other transmit antennas transmitting a nominal estimate to take account of undetected symbols and noise, and selecting and storing one or more most likely combinations of said most likely symbol values transmitted at said first antenna and said permitted symbol values transmitted at said second antenna,
then, in relation to any further transmit antennas, iteratively determining for each stored most likely combination of symbol values the likelihood of said most likely combination having been transmitted on transmit antenna previously considered, in combination with, for each permitted symbol value, a further transmit antenna having transmitted that permitted symbol value and further in combination with all other transmit antennas transmitting a nominal estimate to take account of undetected symbols and noise, and selecting and storing one or more most likely combinations of said most likely combinations transmitted at
said previously considered antennas and said permitted symbol values
transmitted at said further antenna; and
determining an approximation of the likelihood that a transmit antenna has transmitted one of said permitted symbols by determining, for each of the identified combinations, the probability that the transmit antenna has transmitted said symbol in combination with the other transmit antennas transmitting symbols in accordance with said identified combination, and determining the sum of said probabilities, and thereby determining the most likely of said symbols to have been transmitted at said transmit antenna.

2. A method in accordance with claim 1 wherein the nominal symbol estimate is a random variable.

3. A method in accordance with claim 2 wherein the mean of the random variable is the mean of the set of permitted symbols.

4. A method in accordance with claim 3 wherein the variance of the random variable is the sum of the variance of a noise estimate and the variance of the set of permitted symbols.

5. A method of processing a signal received from a MIMO transmission, comprising the steps of determining likelihood data in accordance with any preceding claim, and de-interleaving the likelihood data.

6. A method of processing a signal in accordance with claim 5 and further including the step of decoding the de-interleaved data to generate likelihood data.

7. A method of processing a signal in accordance with claim 6 wherein the decoding step comprises applying a channel decoding process to the de-interleaved data.

8. A method of processing a signal in accordance with claim 6 and further comprising the step of generating an audio output on the basis of the resultant likelihood information.

9. A method of processing a signal in accordance with claim 6, and including the step of generating a visual output on the basis of the resultant likelihood data.

10. A method of communicating information in a MIMO system, comprising a transmitter having a plurality of transmit antennas and a receiver comprising a plurality of receive antennas, comprising encoding information as symbols, each symbol being a member of a set of permitted symbols, and transmitting the symbols at the transmit antennas modulated in accordance with space and time and/or frequency, then decoding the information at the receiver in accordance with the method of detecting information of claim 1.

11. A decoder for decoding information borne on a signal received from a transmission over a MIMO channel from a plurality of transmit antennas, the signal being received on a plurality of receive antennas, the information being encoded as a string of symbols over space and time and/or frequency, each transmitted symbol having one of a plurality of values, comprising:
likely combination determining means for identifying a plurality of combinations of permitted symbol values, the combinations being substantially most likely to be presented at the transmit antennas in a given frame, including
likelihood determining means for determining, in an initial mode of operation, for each permitted symbol value, the likelihood of a first transmit antenna having transmitted that symbol value, in combination with all other transmit antennas transmitting a nominal estimate to take account of undetected symbols and noise, and in a further iterative mode of operation, the likelihood of the already considered transmit antenna transmitting one of the stored most likely symbol values or the already considered transmit antennas transmitting one of the most likely combinations of symbol values as the case may be, in combination with a further antenna transmitting, for each permitted symbol value, that symbol value, and all yet to be considered transmit antennas transmitting a nominal estimate to take account of undetected symbols and noise,
storage means for storing a selected number, smaller than the number of
permitted symbol values, of said most likely symbol values with respect to said
initial mode of operation or combinations of values as the case may be; and
likelihood data determining means for determining an approximation of the likelihood that a transmit antenna has transmitted one of said permitted symbols including probability component determining means for determining, for each of the identified combinations, the probability that the transmit antenna has transmitted said symbol in combination with the other transmit antennas transmitting symbols in accordance with said identified combination, and probability summation means for determining the sum of said probabilities, and thereby determining the most likely of said symbols to have been transmitted at said transmit antenna.

12. A decoder in accordance with claim 11 wherein the nominal symbol estimate is a random variable.

13. A decoder in accordance with claim 12 wherein the mean of the random variable is the mean of the set of permitted symbols.

14. A decoder in accordance with claim 13 wherein the variance of the random variable is the sum of the variance of a noise estimate and the variance of the set of permitted symbols.

15. Data processing apparatus operable to receive and process a signal received from a MIMO transmission, comprising a decoder in accordance with claim 11 to produce likelihood data relating to received symbols and a de-interleaver for de-interleaving the likelihood data.

16. Data processing apparatus in accordance with claim 15 and further including a decoder for decoding the channel code to generate likelihood information.

17. Data processing apparatus in accordance with claim 16 and further comprising audio output means operable to generate an audio output on the basis of the resultant likelihood information.

18. Data processing apparatus in accordance with claim 16 and comprising visual output means operable to generate a visual output on the basis of the resultant likelihood information.

19. A MIMO communications system, comprising a transmitter having a plurality of transmit antennas operable to encode information as symbols, each symbol being a member of a set of permitted symbols, and to transmit the symbols at the transmit antennas modulated in accordance with space and time and/or frequency, and a receiver comprising a plurality of receive antennas, operable to decoding the information, and the receiver comprising a decoder in accordance with claim 11.

20. A MIMO communications system, comprising a transmitter having a plurality of transmit antennas operable to encode information as symbols, each symbol being a member of a set of permitted symbols, and to transmitting the symbols at the transmit antennas modulated in accordance with space and time and/or frequency, and a receiver comprising a plurality of receive antennas, operable to decoding the information, and the receiver comprising a data processing apparatus in accordance with claim 15.

21. A computer program product, comprising computer executable instructions, operable to configure a general purpose computer to perform the method of claim 1.
